(19) United States
(12) Patent Application Publication
(10) Pub. No.: US 2023/0167739 A1
(43) Pub. Date: Jun. 1, 2023

(54) METHOD AND SYSTEM FOR REAL-TIME PREDICTION OF JAMMING IN TBM TUNNELING

(71) Applicant: SHANDONG UNIVERSITY, Jinan, Shandong (CN)

(72) Inventors: Shucai LI, Jinan (CN); Daohong QIU, Jinan (CN); Yiguo XUE, Jinan (CN); Chunjin LIN, Jinan (CN); Yusong FU, Jinan (CN); Maoxin SU, Jinan (CN); Zhiqiang LI, Jinan (CN); Kang FU, Jinan (CN); Huimin GONG, Jinan (CN); Jianxiang FENG, Jinan (CN); Yang LIU, Jinan (CN)

(73) Assignee: SHANDONG UNIVERSITY, Jinan, Shandong (CN)

(21) Appl. No.: 17/779,918

(22) PCT Filed: Jun. 18, 2021
(86) PCT No.: PCT/CN2021/100803

§ 371 Date: May 25, 2022

(30) Foreign Application Priority Data
Dec. 9, 2020 (CN) 202011431044.1

(51) Int. Cl. E21D 9/00; G01V 1/52; G01V 1/50

(52) U.S. Cl. CPC E21D 9/003; G01V 1/52; G01V 1/50

(57) ABSTRACT

A method and system for real-time prediction of jamming in TBM tunneling. The method includes: (1) obtaining actually measured TSP physical property parameters by applying a TSP method; (2) analyzing value ranges and change trends of the TSP physical property parameters obtained in real time; (3) establishing a TSP physical property parameter sample database of a TBM tunnel; (4) establishing a mapping relationship between TSP physical property parameters and occurrence or not of jamming; (5) establishing a mapping relationship between time sequence values of tunneling parameters and occurrence or not of jamming; and (6) forecasting a TBM jamming risk in real time, and storing reliable data into the TSP physical property parameter sample database. The method and system can effectively obtain a state of surrounding rocks in time, thereby providing real-time forecasting of TBM tunneling jamming, avoiding occurrence of accidents to some extent, and improving the TBM tunneling efficiency.

### TECHNICAL FIELD

The present disclosure belongs to the field of TBM tunneling technologies, and relates to a method and system for real-time prediction of jamming in TBM tunneling.

### BACKGROUND

The description in this section merely provides background information related to the present disclosure and does not necessarily constitute the prior art.

Different from conventional drilling and blasting methods, TBM tunneling has advantages such as high speed, good shaping, and low pollution, but is lack of adaptability to stratum changes. As a result, TBM jamming occurs frequently, which limits the working efficiency of the TBM to some extent. Therefore, an accurate judgement needs to be made on TBM tunneling to better exert the advantage of TBM tunneling in efficiency.

Some methods for real-time prediction of jamming in TBM tunneling have been disclosed in the prior art. However, such systems and methods in the prior art have the following problems: only a single prediction method or system is used for real-time prediction, and once a certain system component fails, the prediction accuracy cannot be ensured. In addition, in the prior art, after the obtaining of geological information and the prediction of jamming, data of the jamming section is not saved, leading to a waste of data.

### SUMMARY

To resolve the foregoing problem, the present disclosure provides a method for real-time prediction of jamming in TBM tunneling. In the present invention, results predicted by a plurality of methods are combined to provide real-time forecasting, and data of jamming sections are stored to form a large jamming section database, so as to avoid jamming. In this way, the prediction accuracy and fault tolerance are improved, thereby avoiding the large amount of time and material costs required due to jamming. In addition, the stored data may be applied to other TBM tunneling projects, thereby facilitating the TBM tunneling construction.

According to some embodiments, the present disclosure adopts the following technical solutions:

According to a first aspect, the present disclosure provides a method for real-time prediction of jamming in TBM tunneling, including:

(1) obtaining an actually measured tunnel seismic prediction (TSP) physical property parameter in front of a TBM by applying a TSP method, as a rock parameter index judging the stability of surrounding rocks in front of a tunnel face of a TBM tunnel;

(2) analyzing value ranges and change trends of the obtained TSP physical property parameters, to preliminarily infer an actual geological situation of the surrounding rocks in a tunnel in front of the tunnel face;

(3) recording the TSP physical property parameter obtained through advanced geological detection and an inferred result, and recording a surrounding rock condition, occurrence or not of collapse, and occurrence or not of jamming that are disclosed by tunneling, to establish a TSP physical property parameter sample database of the TBM tunnel;

(4) establishing a mapping relationship between TSP physical property parameters and occurrence or not of jamming by using a back-propagation (BP) neural network, training a model by using the sample database, obtaining a prediction result of whether jamming occurs within a certain mileage range in front of the tunnel face of the TBM tunneling, and making a comprehensive judgment based on the prediction result;

(5) establishing a TBM tunneling parameter sample database, recording a tunneling parameter value at a current tunneling mileage and occurrence of collapse or jamming in real time, and establishing a mapping relationship between time sequence values of tunneling parameters and occurrence or not of jamming by using a long-short term memory (LSTM) neural network, to predict whether jamming occurs in front of a TBM cutter disk; and

(6) forecasting a TBM jamming risk in real time based on the inferred result, the prediction result of the BP neural network, and a prediction result of the LSTM network, and storing data of some typical jamming sections into a typical sample database.

As an optional implementation, the actually measured TSP physical property parameters in front of a TBM obtained in step (1) include horizontal and vertical wave velocities, a Poisson ratio, static elastic modulus, Young's modulus, and wave impedance.

As an optional implementation, the actually measured physical property parameters in step (1) are acquired by a wave detector fixed on the cutter disk and obtained through related processing.

As an optional implementation, a judgment index in step (2) is that: when general rock mass has relatively high water content, a horizontal wave velocity decreases, leading to an increase in a Poisson ratio, and a change trend of the horizontal wave velocity is used as a judgment basis for water content of rock mass; and the integrity of the rock mass is determined according to relevance or change trends of a Poisson ratio and dynamic Young's modulus of the surrounding rocks.

As an optional implementation, the TSP physical property parameter sample database of the TBM tunnel established in step (3) is mainly obtained by screening TBM physical property parameters of a jamming section of a current tunnel and eliminating apparently inappropriate data, and should be typical.

As an optional implementation, the BP neural network in step (4), as a multi-layer feedforward neural network trained according to an error back propagation algorithm, repeatedly trains the model and continuously adjust training parameters of the neural network until the accuracy of test data reaches a target requirement, to obtain a BP neural network classifier, so as to perform mode recognition and make a decision of judging occurrence or not of jamming.

As an optional implementation, the LSTM neural network in step (5), as a recurrent neural network (RNN) including hidden nodes, includes three operations: an input gate, a forget gate, and an output gate, which improves the model recognition speed and accuracy, thereby ensuring the prediction timeliness.

As an optional implementation, the typical sample database in step (6) stores information about TSP physical property parameters, tunneling parameters, and occurrence or not of jamming of corresponding mileages as model training samples, to ensure that the trained model includes relatively high reliability.

According to a second aspect, the present disclosure further provides a system for real-time prediction of jamming in TBM tunneling, including:

a first module, configured to obtain actually measured tunnel seismic prediction (TSP) physical property parameters in front of a TBM by applying a TSP method, as a rock parameter index judging the stability of surrounding rocks in front of a tunnel face of a TBM tunnel;

a second module, configured to analyze value ranges and change trends of the obtained TSP physical property parameters, to preliminarily infer an actual geological situation of the surrounding rocks in a tunnel in front of the tunnel face;

a third module, configured to: record the TSP physical property parameters obtained through advanced geological detection and an inferred result, and record a surrounding rock condition, occurrence or not of collapse, and occurrence or not of jamming that are disclosed by tunneling, to establish a TSP physical property parameter sample database of the TBM tunnel;

a fourth module, configured to: establish a mapping relationship between TSP physical property parameters and occurrence or not of jamming by using a back-propagation (BP) neural network, train a model by using the sample database, obtain a prediction result of whether jamming occurs within a certain mileage range in front of the tunnel face of the TBM tunneling, and make a comprehensive judgment based on the prediction result;

a fifth module, configured to: establish a TBM tunneling parameter sample database, record a tunneling parameter value at a current tunneling mileage and occurrence of collapse or jamming in real time, and establish a mapping relationship between time sequence values of tunneling parameters and occurrence or not of jamming by using a long-short term memory (LSTM) neural network, to predict whether jamming occurs in front of a TBM cutter disk; and

a sixth module, configured to forecast a TBM jamming risk in real time based on the inferred result, the prediction result of the BP neural network, and a prediction result of the LSTM network, and store data of some typical jamming sections into a typical sample database.

According to a third aspect, the present disclosure further provides a server, including a memory, a processor, and a program for real-time prediction of jamming in TBM tunneling that is stored on the memory and executable on the processor, the program for real-time prediction of jamming in TBM tunneling being configured to implement the steps of the method.

According to a fourth aspect, the present disclosure further provides a storage medium, storing a program for real-time prediction of jamming in TBM tunneling, the program for real-time prediction of jamming in TBM tunneling, when executed by a processor, implementing the steps of the method.

Compared with the prior art, the present disclosure has the following beneficial effects:

In the present disclosure, considering the characteristics of TBM tunneling, TSP physical property parameters which are the most readily obtained in the tunneling process are selected as criteria for judging TBM jamming. A TSP physical property parameter sample database of a TBM tunnel is established by analyzing value ranges and change trends of the actually measured physical property parameters, and a mapping relationship between TSP physical property parameters and occurrence or not of jamming is established by using a BP neural network. In addition, a mapping relationship between time sequence values of tunneling parameters and occurrence or not of jamming is established by using a LSTM neural network. Therefore, real-time forecasting of TBM tunneling jamming is provided, occurrence of accidents is avoided to some extent, which improves the TBM tunneling efficiency and facilitates the TBM tunneling construction.

### BRIEF DESCRIPTION OF THE DRAWINGS

The accompanying drawings constituting a part of the present disclosure are used to provide further understanding of the present disclosure. Exemplary embodiments of the present disclosure and descriptions thereof are used to explain the present disclosure, and do not constitute an improper limitation to the present disclosure.

FIG. 1 is a flowchart of implementation steps.

### DETAILED DESCRIPTION

It should be pointed out that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present disclosure. As used herein, the singular form is also intended to include the plural form unless the present invention clearly dictates otherwise. In addition, it should be further understood that, terms “comprise” and/or “include” used in this specification indicate that there are features, steps, operations, devices, components, and/or combinations thereof.

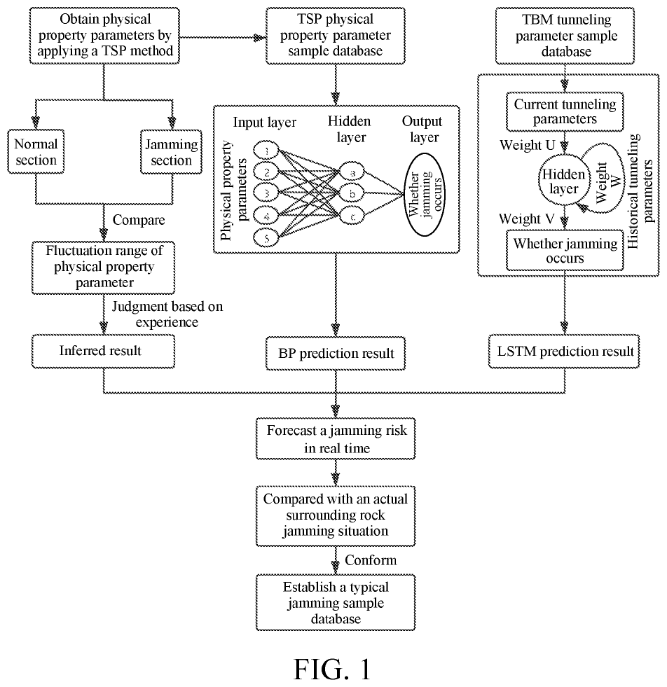

As shown in FIG. 1, this embodiment provides a method for real-time prediction of jamming in TBM tunneling. The present invention collects statistics on and analyzes TSP physical property parameters of existing TBM tunneling jamming sections, to preliminarily judge an actual situation of surrounding rocks in front of a tunnel face by determining value ranges and change trends of the TSP physical property parameters. While the situation of the surrounding rocks is preliminarily judged, the actually measured TSP physical property parameters are further analyzed, to establish a TSP physical property parameter sample database of a TBM tunnel. The sample database may establish a mapping relationship between TSP physical property parameters and occurrence or not of jamming by using a BP neural network. A model is trained by using the sample database, to obtain a prediction result of whether jamming occurs within a certain mileage range in front of a tunnel face of a TBM tunnel. In addition, a TBM tunneling parameter sample database is established, and a mapping relationship between time sequence values of tunneling parameters and occurrence or not of jamming by using a LSTM neural network, to further perform risk assessment on the surrounding rocks in front of the tunnel face, thereby pre-warning a jamming risk of TBM tunneling in real time. When a risk of jamming is found in front of the tunnel face, other advanced geological forecast methods need to be further used to perform further detection, and when a geological situation obtained through detection by using other advanced geological forecast methods conforms to the situation forecast by the present invention, data detected by the present invention is stored in a typical jamming sample database for subsequent use, thereby improving the stability and accuracy of real-time prediction. Specifically, the method for real-time prediction of jamming in TBM tunneling provided in this embodiment includes:

(1) obtaining actually measured tunnel seismic prediction (TSP) physical property parameters in front of a TBM by applying a TSP method, as a rock parameter index judging the stability of surrounding rocks in front of a tunnel face of a TBM tunnel;

(2) analyzing value ranges and change trends of the obtained TSP physical property parameters, to preliminarily infer an actual geological situation of the surrounding rocks in a tunnel in front of the tunnel face;

(3) recording the TSP physical property parameters obtained through advanced geological detection and an inferred result, and recording a surrounding rock condition, occurrence or not of collapse, and occurrence or not of jamming that are disclosed by tunneling, to establish a TSP physical property parameter sample database of the TBM tunnel;

(4) establishing a mapping relationship between TSP physical property parameters and occurrence or not of jamming by using a back-propagation (BP) neural network, training a model by using the sample database, obtaining a prediction result of whether jamming occurs within a certain mileage range in front of the tunnel face of the TBM tunneling, and making a comprehensive judgment based on the prediction result;

(5) establishing a TBM tunneling parameter sample database, recording a tunneling parameter value at a current tunneling mileage and occurrence of collapse or jamming in real time, and establishing a mapping relationship between time sequence values of tunneling parameters and occurrence or not of jamming by using a long-short term memory (LSTM) neural network, to predict whether jamming occurs in front of a TBM cutter disk; and

(6) forecasting a TBM jamming risk in real time based on the inferred result, the prediction result of the BP neural network, and a prediction result of the LSTM network, and storing data of some typical jamming sections into a typical sample database.

As a further limitation, the actually measured TSP physical property parameters in front of a TBM obtained in step (1) include horizontal and vertical wave velocities, a Poisson ratio, static elastic modulus, Young's modulus, and wave impedance.

As a further limitation, the actually measured physical property parameters in step (1) are acquired by a wave detector fixed on the cutter disk and obtained through related processing.

As a further limitation, a judgment index in step (2) is that: when general rock mass has relatively high water content, a horizontal wave velocity decreases, leading to an increase in a Poisson ratio, and a change trend of the horizontal wave velocity is used as a judgment basis for water content of rock mass; and the integrity of the rock mass is determined according to relevance or change trends of a Poisson ratio and dynamic Young's modulus of the surrounding rocks.

As a further limitation, the TSP physical property parameter sample database of the TBM tunnel established in step (3) is mainly obtained by screening TBM physical property parameters of a jamming section of a current tunnel and eliminating apparently inappropriate data, and should be typical.

As a further limitation, the BP neural network in step (4), as a multi-layer feedforward neural network trained according to an error back propagation algorithm, repeatedly trains the model and continuously adjust training parameters of the neural network until the accuracy of test data reaches a target requirement, to obtain a BP neural network classifier, so as to perform mode recognition and make a decision of judging occurrence or not of jamming.

As a further limitation, the LSTM neural network in step (5), as a recurrent neural network (RNN) including hidden nodes, includes three operations: an input gate, a forget gate, and an output gate, which improves the model recognition speed and accuracy, thereby ensuring the prediction timeliness.

As a further limitation, the typical sample database in step (6) stores information about TSP physical property parameters, tunneling parameters, and occurrence or not of jamming of corresponding mileages as model training samples, to ensure that the trained model includes relatively high reliability.

This embodiment further provides a system for real-time prediction of jamming in TBM tunneling, including:

a first module, configured to obtain actually measured tunnel seismic prediction (TSP) physical property parameters in front of a TBM by applying a TSP method, as a rock parameter index judging the stability of surrounding rocks in front of a tunnel face of a TBM tunnel;

a second module, configured to analyze value ranges and change trends of the obtained TSP physical property parameters, to preliminarily infer an actual geological situation of the surrounding rocks in a tunnel in front of the tunnel face;

a third module, configured to: record the TSP physical property parameters obtained through advanced geological detection and an inferred result, and record a surrounding rock condition, occurrence or not of collapse, and occurrence or not of jamming that are disclosed by tunneling, to establish a TSP physical property parameter sample database of the TBM tunnel;

a fourth module, configured to: establish a mapping relationship between TSP physical property parameters and occurrence or not of jamming by using a back-propagation (BP) neural network, train a model by using the sample database, obtain a prediction result of whether jamming occurs within a certain mileage range in front of the tunnel face of the TBM tunneling, and make a comprehensive judgment based on the prediction result;

a fifth module, configured to: establish a TBM tunneling parameter sample database, record a tunneling parameter value at a current tunneling mileage and occurrence of collapse or jamming in real time, and establish a mapping relationship between time sequence values of tunneling parameters and occurrence or not of jamming by using a long-short term memory (LSTM) neural network, to predict whether jamming occurs in front of a TBM cutter disk; and a sixth module, configured to forecast a TBM jamming risk in real time based on the inferred result, the prediction result of the BP neural network, and a prediction result of the LSTM network, and store data of some typical jamming sections into a typical sample database.

Certainly, the first module, the second module, the third module, the fourth module, the fifth module, and the sixth module correspond to the first step, the second step, the third step, the fourth step, the fifth step, and the sixth step, and the modules are the same as examples and application scenarios implemented by the corresponding steps, but are not limited to the content disclosed above. It should be noted that, as a part of the system, the foregoing modules may be performed in, for example, a computer system having a group of computer-executable instructions.

This embodiment further provides a server, including a memory, a processor, and a program for real-time prediction of jamming in TBM tunneling that is stored on the memory and executable on the processor, the program for real-time prediction of jamming in TBM tunneling being configured to implement the steps of the method.

The memory may include a read-only memory and a random-access memory, and provide instructions and data to the processor. A part of the memory may further include a non-volatile random-access memory. For example, the memory may further store information about a device type.

The processor may be a central processing unit (CPU); or the processor may be another general-purpose processor, a digital signal processor (DSP), an application specific integrated circuit (ASIC), a field programmable gate array (FPGA) or another programmable logical device, a discrete gate or a transistor logical device, a discrete hardware component, or the like. The general-purpose processor may be a microprocessor, or the processor may be any conventional processor, or the like.

This embodiment further provides a storage medium, storing a program for real-time prediction of jamming in TBM tunneling, the program for real-time prediction of jamming in TBM tunneling, when executed by a processor, implementing the steps of the method.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may further be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

The specific implementations of the present disclosure are described above with reference to the accompanying drawings, but are not intended to limit the protection scope of the present disclosure. A person skilled in the art should understand that various modifications or deformations may be made without creative efforts based on the technical solutions of the present disclosure, and such modifications or deformations shall fall within the protection scope of the present disclosure.

1. A method for real-time prediction of jamming in TBM tunneling, comprising:
(1) obtaining actually measured tunnel seismic prediction (TSP) physical property parameters in front of a TBM by applying a TSP method, as a rock parameter index judging the stability of surrounding rocks in front of a tunnel face of a TBM tunnel;
(2) analyzing value ranges and change trends of the obtained TSP physical property parameters, to preliminarily infer an actual geological situation of the surrounding rocks in a tunnel in front of the tunnel face;
(3) recording the TSP physical property parameters obtained through advanced geological exploration and an inferred result, and recording a surrounding rock condition, occurrence or not of collapse, and occurrence or not of jamming that are disclosed by tunneling, to establish a TSP physical property parameter sample database of the TBM tunnel;
(4) establishing a mapping relationship between TSP physical property parameters and occurrence or not of jamming by using a back-propagation (BP) neural network, training a model by using the sample database, obtaining a prediction result of whether jamming occurs within a preset mileage range in front of the tunnel face of the TBM tunneling, and making a comprehensive judgment based on the prediction result;
(5) establishing a TBM tunneling parameter sample database, recording a tunneling parameter value at a current tunneling mileage and occurrence of collapse or jamming in real time, and establishing a mapping relationship between time sequence values of tunneling parameters and occurrence or not of jamming by using a long-short term memory (LSTM) neural network, to predict whether jamming occurs in front of a TBM cutter disk; and
(6) forecasting a TBM jamming risk in real time based on the inferred result, the prediction result of the BP neural network, and a prediction result of the LSTM network, and storing data of some typical jamming sections into a typical sample database.

2. The method for real-time prediction of jamming in TBM tunneling according to claim 1, wherein the actually measured TSP physical property parameters in front of a TBM obtained in step (1) comprise horizontal and vertical wave velocities, a Poisson ratio, static elastic modulus, Young's modulus, and wave impedance.

3. The method for real-time prediction of jamming in TBM tunneling according to claim 2, wherein the actually measured TSP physical property parameters are acquired by a wave detector fixed on the cutter disk and obtained through related processing.

4. The method for real-time prediction of jamming in TBM tunneling according to claim 1, wherein a judgment index in step (2) is that: when general rock mass has relatively high water content, a horizontal wave velocity decreases, leading to an increase in a Poisson ratio, and a change trend of the horizontal wave velocity is used as a judgment basis for water content of rock mass; and the integrity of the rock mass is determined according to relevance or change trends of a Poisson ratio and dynamic Young's modulus of the surrounding rocks.

5. The method for real-time prediction of jamming in TBM tunneling according to claim 1, wherein the TSP physical property parameter sample database of the TBM tunnel established in step (3) is mainly obtained by screening TBM physical property parameters of a jamming section of a current tunnel and eliminating apparently inappropriate data.

6. The method for real-time prediction of jamming in TBM tunneling according to claim 1, wherein the BP neural network in step (4) repeatedly trains the model and continuously adjust training parameters of the neural network until the accuracy of test data reaches a target requirement, to obtain a BP neural network classifier, so as to perform mode recognition and make a decision of judging occurrence or not of jamming.

7. The method for real-time prediction of jamming in TBM tunneling according to claim 1, wherein the typical sample database in step (6) stores information about TSP physical property parameters, tunneling parameters, and occurrence or not of jamming of corresponding mileages as model training samples, to ensure that the trained model comprises relatively high reliability.

8. A system for real-time prediction of jamming in TBM tunneling, comprising:
a first module, configured to obtain an actually measured tunnel seismic prediction (TSP) physical property parameter in front of a TBM by applying a TSP method, as a rock parameter index judging the stability of surrounding rocks in front of a tunnel face of a TBM tunnel;
a second module, configured to analyze value ranges and change trends of the obtained TSP physical property parameters, to preliminarily infer an actual geological situation of the surrounding rocks in a tunnel in front of the tunnel face;
a third module, configured to: record the TSP physical property parameters obtained through advanced geological detection and an inferred result, and record a surrounding rock condition, occurrence or not of collapse, and occurrence or not of jamming that are disclosed by tunneling, to establish a TSP physical property parameter sample database of the TBM tunnel;
a fourth module, configured to: establish a mapping relationship between TSP physical property parameters and occurrence or not of jamming by using a back-propagation (BP) neural network, train a model by using the sample database, obtain a prediction result of whether jamming occurs within a certain mileage range in front of the tunnel face of the TBM tunneling, and make a comprehensive judgment based on the prediction result;
a fifth module, configured to: establish a TBM tunneling parameter sample database, record a tunneling parameter value at a current tunneling mileage and occurrence of collapse or jamming in real time, and establish a mapping relationship between time sequence values of tunneling parameters and occurrence or not of jamming by using a long-short term memory (LSTM) neural network, to predict whether jamming occurs in front of a TBM cutter disk; and
a sixth module, configured to forecast a TBM jamming risk in real time based on the inferred result, the prediction result of the BP neural network, and a prediction result of the LSTM network, and store data of some typical jamming sections into a typical sample database.

9. A server, comprising a memory, a processor, and a program for real-time prediction of jamming in TBM tunneling that is stored on the memory and executable on the processor, the program for real-time prediction of jamming in TBM tunneling being configured to implement the steps of the method according to claim 1.

10. A storage medium, storing a program for real-time prediction of jamming in TBM tunneling, the program for real-time prediction of jamming in TBM tunneling, when executed by a processor, implementing the steps of the method according to claim 1.
